(19) United States
(12) Patent Application Publication
(10) Pub. No.: US 2019/0364619 A1
(43) Pub. Date: Nov. 28, 2019

(54) METHOD FOR THE PRODUCTION OF A HEATING DEVICE AND HEATING DEVICE PRODUCED THEREBY

(71) Applicant: E.G.O. Elektro-Geraetebau GmbH, Oberderdingen (DE)

(72) Inventors: Konrad Schoenemann, Sulzfeld (DE); Volker Block, Bretten (DE); Michael Tafferner, Malsch (DE); Tobias Albert, Kraichtal (DE); Kay Schmidt, Oberderdingen-Flehingen (DE); Alfred Suss, Bretten (DE); Roland Muehlnikel, Bretten (DE); Daniel Fuchs, Linkenheim-Hochstetten (DE)

(21) Appl. No.: 16/419,122

(22) Filed: May 22, 2019

(30) Foreign Application Priority Data
May 25, 2018 (DE) 10 2018 208 252.9

(51) Int. Cl. H05B 3/46; H05B 3/06

(52) U.S. Cl. CPC H05B 3/46; H05B 3/06; H05B 2203/013; H05B 2203/005; H05B 2203/017

(57) ABSTRACT

In a method for the production of a heating device, comprising a support that is curved along one direction and at least one flat thick film heating element disposed thereon, the support and/or the heating device itself are processed from a tube, in particular a circular-cylindrical tube. For that purpose a tube wall is severed in one direction which does not exclusively have a peripheral direction component so that the support is not a circumferential tube. The thick film heating element can be applied before or after the severing.

### CROSS-REFERENCE TO RELATED APPLICATIONS

This application claims priority to German Application No. 10 2018 208 252.9, filed May 25, 2018, the contents of which are hereby incorporated herein in its entirety by reference.

### Field of Application and Prior Art

The invention relates to a method for the production of a heating device and a heating device produced thereby.

U.S. Pat. No. 7,941,884 B2 discloses a heating device which is curved in its longitudinal extension, that is, along the longitudinal direction. Thus, the heating device can achieve a type of trough shape. A number of elongate heating elements are attached on one side, preferably on the outwardly curved side. This heating device can be employed in a washing machine (laundry machine) in order to heat water below a drum in the so-called sump of the laundry machine. Due to the curved shape, it can be adapted to the curvature of the drum and thereby also be installed well in the specific installation space. Furthermore, due to the trough shape, wherein the curvature is facing downwards in the installed condition, a minor amount of water may be stored or retained, so to speak, which water may then be heated and evaporated, for example for a steam treatment of laundry in the washing machine.

### Problem and Solution

The invention is based on the problem of providing a method for the production of a heating device of the kind mentioned in the introductory part and also a corresponding heating device, with which prior art problems can be solved and it is possible, in particular, to be able to produce a heating device advantageously with low expenditure and as high as possible process reliability.

This problem is solved by a method having the features of Claim 1, and also by a correspondingly produced heating device having the features of Claim 22. Advantageous and preferred refinements of the invention are the subject matter of the further claims and will be explained in greater detail in the text which follows. Therein, some of the features will be described only for the method or only for the heating device. However, irrespective of this, they are intended to be able to apply both for the method and the heating device standing alone and independently of each other. The wording of the claims is incorporated in the content of the description by explicit reference.

Provision is made that the heating device has a support and at least one flat heating element arranged thereon. The latter can be applied as a thick film heating element, that is, in a thick layer process. As an alternative, any other layered heating element can be used which has, for example, been applied by other per se known methods such as thin layer process, thermal spraying, wire injection techniques, plasma processes. Therein, the support is curved along one direction, in particular curved exclusively along one direction, that is, only about one single axis. Said axis extends preferably in parallel to a longitudinal direction of the support.

According to the invention is provided that the support and/or the heating device itself is processed from a tube, in particular a cylindrical or even circular-cylindrical tube. For this processing, a tube wall is severed in one direction which does not exclusively have a peripheral direction component, preferably extends at least partially along the longitudinal direction and includes a longitudinal direction component, respectively. This means that the tube is not merely cut to length or severed, quasi, to cut off an entire circumferential piece. The support is then, so to speak, also severed obliquely or at right angles. Furthermore, the support is advantageously not closed circumferentially or not closed in a ring shape.

Thus, with the invention it is of secondary importance whether the at least one flat heating element is applied to the tube or the support before the severing or after the severing. The essence of the invention is in the severing of a tube, in order to produce or to obtain a support or the heating device so as to obtain a support curved in the longitudinal direction to provide a heating device. Thereby, bending of an initially flat support in the desired curved shape for the completed heating device can be avoided, which is complex, as the case may be, in particular when a uniform curvature is required. Methods for the production of a tube, in particular of a cylindrical tube or a circular-cylindrical tube, are indeed well-known and easy to be performed in a technical scale. From such a tube, in turn, multiple supports can be cut out from such a tube or the tube can be severed into a number of individual supports. Thus, heating elements can be produced by a combination of axial and radial cuts into such a tube. As an alternative, they can be produced by oblique or spiral-shaped cuts or even only by axial cuts.

In an embodiment of the invention, it can be provided that the tube is severed at least once along one direction which is exactly parallel or at an angle of up to 15° in relation to a central longitudinal axis of the tube. Thus, the tube can be severed exactly in the longitudinal direction in a variant. Preferably, severing is made only along said direction or longitudinal direction, wherein per support in each case severing can be made additionally exactly once along the peripheral direction. Thereby it is possible that a support or a heating device produced therewith is shorter than the entire tube, for example has an integral part fraction of the length thereof. Thus, a longer tube can be prepared as a so-called versatile application. Therefrom individual supports or individual heating devices are then separated, wherein layers or components or functional units are already included on the support. As an alternative, a tube can be severed only in the direction from one end to the other end, in particular in parallel to a longitudinal direction, so that the two ends of the tube each provide two opposed end edges of the support.

Advantageously, the tube can have a circular cross section, in particular be circular cylindrical. Such a tube is obviously very easy to be produced in a technical scale and then also has very even characteristics.

Preferably, the heating device or the support of the heating device has a length that is greater than the width, in particular greater than the width correspondingly along a partial circumference. Therein, such a heating device or the corresponding support can have a transverse curvature with a uniform curvature along the longitudinal direction so that the curvature can be located about an axis parallel to the longitudinal direction of the heating device or the support.

In a further embodiment of the invention, it can be provided that a tube is severed or separated in individual heating devices or supports such that no remainder is left, in particular no remainder except for roundings of corners. Thereby, a most efficient material utilization is possible.

An above mentioned heating element, as an alternative also any other functional unit, can preferably be provided on or applied to an exterior side of the curved heating device or the curved support, wherein this side is a convex exterior side. This convex curved exterior side can easily be produced on a separated support having a curved shape, on a closed tube anyway.

In a first embodiment of the invention, it is possible that the heating device is produced at least with many or all components or functional units, which have to be applied on a large area or in a layer, by corresponding application before the tube is severed for separation. Therein, said components or functional units are advantageously provided on the convexly curved exterior side of the heating device. Subsequently, separation is performed and for that purpose the tube is severed. Then still further components or functional units can be attached or fixed to the heating device, however, these are then preferably not applied in a layer structure but as discrete components, in particular SMD components and/or connector units.

The application of the layered components or functional units onto the entire tube prior to severing or separating has the advantage that this can be performed on a so-called versatile application, what possibly is more simple or more efficient. Especially printing in a thick layer process is possible with tubes so that they can also be used in a versatile application.

In a second alternative embodiment of the invention, the tube is severed a number of times for separating in a number of supports, so that then the above mentioned components or functional units can be applied to respective individual supports, advantageously on a large area or in a layer. Thus, a deformation of the support, which could occur during severing of the tube for separation into multiple supports, can be made at a time when mechanically sensitive layers or components and functional units, respectively, are not yet applied. Furthermore, an additional option is to deform separated supports to some extent to a shape that would not be achieved by exclusively severing the tube.

In the two above mentioned alternatives, it is considered to be advantageous that the components or functional units are disposed or applied on the convex exterior side.

According to a further embodiment of the invention, it is possible to provide connector panels as electrical power connectors for the at least one heating element. Advantageously, said connector panels or electrical power connectors are provided on one side of the tube or support, on which a heating element is also provided. Thereby, implementation of a supply line is facilitated. According to a first variant of the invention, said connector panels, preferably for all heating elements of a heating device, can be applied in a central region which is located in the centre or in the middle, as seen in the longitudinal direction of the heating device. Thus, it can be a geometrical central region or middle region. Heating elements are provided on both sides of said central region in the longitudinal direction, wherein particularly preferred a distribution of the heating capacity of the heating elements is such that it is approximately equal on both sides of the connector panels. What can be achieved thereby is that in said central region with the connector panels excessive temperature increase by concentration of heating capacity does not occur, what is beneficial for mechanical stability and dimensional stability, respectively, of the heating device and for steady generation of the heating capacity. Even in case of a heating element with a plurality of heating circuits thereon, which can be operated independently of each other, or even in common, as required, the respective or all of the electrical connectors can be provided together in such a central region.

The heating device can have at least two separately operable heating elements on a single support, wherein these two separately operable heating elements are advantageously disposed in different regions on the support. The elements or their surfaces or heating regions do not overlap or cover each other and are not interlaced. Thus, they are separated from each other as to heating activity. However, they can also cooperate in common operation and heat a common large area.

According to a second variant of the invention, it can be provided that a connector portion protrudes from the support in a lateral direction. Therein, a longitudinal outer edge can extend in the direction of an outer edge of the support, preferably as a prolongation or in a straight line, so to speak. Such a direction can be transverse to the longitudinal direction of the support. On said protruding connector portion, said connector panels can be provided. If the heating device or the support has a largely square, trapezoidal or even rectangular shape, the connector portion can protrude from said shape or project beyond. Thus, the remaining surface of the support is available as a heating surface. Furthermore, a temperature on the connector portion and on the connector panels, respectively, is somewhat reduced.

In an embodiment of the invention, it can be provided that heating conductors of a heating element extend in the longitudinal direction of the support or the heating device and/or at right angles to an apex line of the heating device or the support. As a result, a meandering extension can be achieved. For angulations and U-shaped reversals it can be provided that these are produced by other contact material. Thereby, the material of the heating element itself does not have these angulations or reversals, what is better for current conduction or generation of heating capacity.

These and further features may be gathered from the claims, but also from the description and the drawings, with the individual features being capable of being implemented in each case by themselves or severally in the form of sub-combinations in an embodiment of the invention and in other fields and being capable of constituting advantageous and independently patentable versions for which protection is claimed here. The subdivision of the application into individual sections and intermediate headings does not restrict the general validity of the statements made under these.

### BRIEF DESCRIPTION OF THE DRAWINGS

Exemplary embodiments of the invention are schematically illustrated in the drawings and will be explained in greater detail in the text which follows. In the drawings:

FIG. 1 shows an oblique view of a circular-cylindrical tube, where components of a heating device according to the invention are applied on the exterior side,

FIG. 2 shows the tube of FIG. 1 with layered heating elements applied on the exterior side and dashed separating lines to be severed by a cutting laser,

FIG. 3 shows an oblique view corresponding to FIG. 2 of a heating device separated by severing from the tube of FIG. 2,

FIG. 4 shows a view of the heating device to FIG. 3 on the upper edge for illustrating the curvature, and

FIG. 5 shows a modification of a curved heating element with a laterally protruding connector portion for electrical connection.

### DETAILED DESCRIPTION OF THE EXEMPLARY EMBODIMENTS

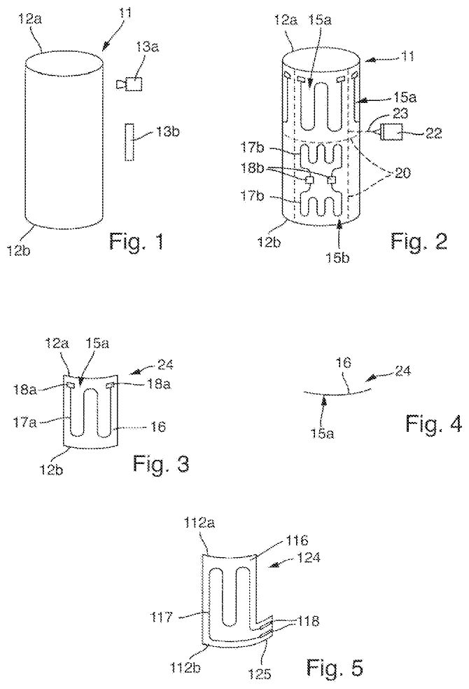

FIG. 1 shows a circular-cylindrical tube 11, advantageously composed of metal or steel. The tube can be produced from a rectangular sheet metal by bending and welding on the abutting edges. This tube 11 is intended to be a support for heating devices according to the invention, which devices are built from said tube by the manner and means according to the invention and then separated therefrom.

The tube 11 has an upper rim 12a and a lower rim 12b, each forming a circle. The tube 11 is also cylindrical.

In a schematic and greatly simplified illustration are shown a spraying device 13a and a printing device 13b, in order to allow application of layers and functional units, respectively, onto the exterior side of the tube 11. In that context, the spraying device 13a is used for thermal spraying or plasma spraying, as is per se known to those skilled in the art. The printing device 13b is likewise used for the application of layers and functional units, respectively, and in particular is a screen printing device. The corresponding techniques are known to those skilled in the art and suitable for such tubes, even the screen printing method. Advantageously, only one of the two application techniques is used, wherein a combination is also possible.

FIG. 2 illustrates how a number of heating elements are applied to the tube 11, for sake of clarity, heating elements 15a in an upper half and heating elements 15b in a lower half. Dashed separating lines 20 divide the tube once in half along its length so that in the upper half the heating elements 15a are provided. In the lower half the heating elements 15b are provided. The corresponding regions of the tube wall or the metal sheet then form the respective support of the respective heating element. Severing is made along the dashed separating lines 20 using a cutting laser 22, here subsequent to partial or complete finishing of printing or providing of layers thereon.

FIG. 2 illustrates in a lower region of the tube 11 an alternative heating element 15b. With this heating element two connector panels 18b are provided in a central region along its length, meandering heating conductors 17b extending towards both sides. As a result, improved distribution of the heating capacity on a finished flat heating device can be achieved. Otherwise, in the central region of the corresponding support, that is, between the two heating conductors 17b, a concentration of heating capacity could occur with local excessive heating, since here the distance to the outer regions and outer edges, respectively, is greatest and, thus, heat dissipation is least.

In a further above mentioned embodiment of the invention, another connector panel 18b could be provided in the central region so that both the heating conductors 17b can be led with a respective end to a single connector panel 18b in common. The respective other end can then respectively be led to a distinct connector panel 18b so that the two heating conductors 17b can also be operated independently of each other and thereby individually, in addition to a common operation.

By severing the tube 11 or the cutting out, a heating device 24 according to FIG. 3 is obtained. The heating device includes a support 16 which is curved and has a rectangular shape when rolled out flat. It is one part of the wall of the tube 11 in FIG. 2. The corners may be rounded, but this is not mandatory. The rectangular shape allows optimum utilization of the tube 11 in versatile application with equal orientation of all heating elements 15 thereon. Trapezoidal supports or heating devices could also be cut out, which would then allow an optimum, namely complete utilization of the surface area of the tube. Therein, the heating elements intended thereon or other functional units would have to be provided on adjacent supports or heating devices, correspondingly turned by 180°.

The heating element 15a on the support 16 has two spaced connector panels 18a and 18b near the upper rim 12a to the right and to the left. A heating conductor 17a, here in meandering shape, extends between these panels in order to cover the surface of the support 16 with only a single heating conductor.

It is readily apparent from FIGS. 1 to 3 that it would, in principle, also be possible to cut individual, slightly curved supports according to FIG. 3 from the circular-cylindrical tube 11 of FIG. 1 immediately using a cutting laser 22, however, yet without layered structure or without functional units thereon. Heating conductor 17a and connector panels 18a can then be applied subsequently. Likewise, at least one insulation layer or dielectric layer can be applied previously on that side of the cut out support on which the further structure is to be made. Therein, intermediate forms can also be provided. For example, it can be provided that an insulation layer and/or dielectric layer are applied extensively on a complete tube according to FIG. 1. The layers can be full surface, as an alternative, they can also be left blank in narrow regions along the later separating line 20. For such a surface, it may possibly even be provided that it is applied to the entire tube, then the tube is severed into individual supports, and thereon in turn, in particular on said applied flat layer, further functional units can be applied, such as heating conductors and connectors.

The top view of FIG. 4 shows the curved profile of the heating device 24. The heating element 15a is applied on the side of the support 16 facing downwards in the Figure, that is, on the convexly outwards curved side. Generally, it could also be the other side or even on both sides. However, FIGS. 1 to 4 illustrate that, on the inner side in the tube 11, a functional unit with a filigree structure could be printed on only with greater effort. In case functional units were to be provided there, it is advisable to apply them not earlier than after the separating of the tube 11 or cutting out of supports.

FIG. 5 shows a modification of a heating device 124, illustrated with a support 116 which is largely a curved rectangle corresponding to the heating device 24 of FIGS. 3 and 4. However, on the bottom right, a connector portion 125 protrudes to the side in the type of a rectangular panel or a wide lug. On said connector portion 125 are provided two narrow elongate connector panels 118 which reach up to the edge of the connector portion 125 facing in the peripheral direction. A heating conductor 117 comes out from these two connector panels 118, which heating conductor again, similar to FIG. 3, has a meandering shape. Thus, the surface of the support 116 can be largely well covered by a single heating conductor, for a most evenly distributed surface heating capacity. On this laterally protruding connector portion 125, a connector plug (not illustrated) can be plugged on as an electrical connector. As an alternative, connector housings having metallic contacts could be welded to said connector panels 18 or to connector panels of the heating element 15b.

Even if a tube is coated or printed on the surface, for example according to FIG. 2, a further step for application of a layer or of components can be included after the separating according to FIG. 3 or 5, for example for individualization. Likewise, after the separating, other steps can be included like a per se well-known matching of the resistance value of a heating conductor 17 to a predefined value.

If on a tube the step of severing into individual supports is performed initially, and further layers or functional components are attached only subsequently, then deformation of the in itself curved individual support can be performed after severing and before any further application. After the application of layers or functional components, such deformation is generally no longer possible, since otherwise these would be damaged or even destroyed.

1. Method for the production of a heating device, said heating device comprising:
a support,
at least one flat heating element disposed on said support,
wherein said support is curved along one direction,
wherein said support or said heating device itself is processed from a tube, including therefor a step that, for this purpose, a tube wall is severed in one direction,
wherein said direction does not exclusively have a peripheral direction component.

2. Method according to claim 1, wherein said at least one flat heating element is applied on said support applied as a thick film heating element.

3. Method according to claim 1, wherein said tube is severed at least once along one direction which is parallel to a central longitudinal axis of said tube.

4. Method according to claim 3, wherein said severing is made only along said direction, wherein additionally severing is made once along said peripheral direction.

5. Method according to claim 1, wherein said tube has a circular cylindrical cross section.

6. Method according to claim 1, wherein said heating device and said support, respectively, have a length being greater than its width, wherein said heating device and said support, respectively, have a transverse curvature with a uniform curvature along a longitudinal direction.

7. Method according to claim 6, wherein said transverse curvature is about an axis parallel to said longitudinal direction.

8. Method according to claim 1, wherein said entire tube is severed a number of times in multiple heating devices, in each case severed in a direction parallel to a central longitudinal axis of said tube.

9. Method according to claim 8, wherein said tube is also severed at least once along a peripheral direction being parallel to a central longitudinal axis of said tube.

10. Method according to claim 8, wherein said tube is separated to form multiple heating devices without remainder.

11. Method according to claim 1, wherein said flat heating element is a thick film heating element.

12. Method according to claim 11, wherein said flat heating element is provided on an exterior side of said curved heating device and said curved support, respectively.

13. Method according to claim 1, wherein said heating device is produced at least with all components or functional units being applied on a large area or in a layer onto said tube, before said tube is severed for separation.

14. Method according to claim 11, wherein said components or said functional units are provided on an exterior side of said curved heating device and said curved support, respectively.

15. Method according to claim 1, wherein said heating device is produced at least with all components or functional units being applied on a large area or in a layer on said support, after said tube has been severed for separation.

16. Method according to claim 15, wherein said flat heating element is a thick film heating element, wherein said components or functional units are provided on said exterior side of said curved heating device and said curved support, respectively.

17. Method according to claim 1, wherein all said components or functional units that have been produced on a large area or in a layer on said support, are applied using a thick layer process.

18. Method according to claim 15, wherein said connector panels are applied as electrical power connectors for said at least one heating element.

19. Method according to claim 18, wherein said connector panels are applied as electrical power connectors for all said heating elements of a heating device, in a central region as seen in a longitudinal direction of said heating device.

20. Method according to claim 19, wherein said connector panels are also located in a central region of a distribution of said heating elements of said heating device and said support, respectively.

21. Method according to claim 20, wherein said connector panels are applied using a thick layer process.

22. Heating device being produced by a method according to claim 1.

23. Heating device according to claim 22, wherein said connector panels are applied as electrical power connectors for said at least one heating element.

24. Heating device according to claim 23, wherein said connector panels are applied as electrical power connectors for all said heating elements of one said heating device, in a central region as seen in a longitudinal direction of said heating device.

25. Heating device according to claim 23, wherein said connector panels are also located in a central region of the distribution of said heating elements of said heating device and said support, respectively.

26. Heating device according to claim 23, wherein said heating device has two heating elements on said unique support, both capable of being operated separately, wherein said two separately operable heating elements are disposed in different regions on said support and do not overlap or cover and are not interlaced.

27. Heating device according to claim 22, wherein a connector portion protrudes from said support in a lateral direction with a longitudinal outer edge in a direction of an outer edge of said support.
